(19) United States
(12) Patent Application Publication
(10) Pub. No.: US 2026/0091329 A1
(43) Pub. Date: Apr. 2, 2026

(54) SCREEN, IN PARTICULAR PRESSURE SCREEN

(71) Applicant: Andritz Fiedler GmbH, Regensburg (DE)

(72) Inventors: Dietmar SCHERER, Teugn (DE); Michael REINSTEIN, Teublitz (DE); Florian LINGAUER, Regenstauf (DE)

(21) Appl. No.: 19/120,221

(22) PCT Filed: Oct. 9, 2023
(86) PCT No.: PCT/EP2023/077869

§ 371 Date: Apr. 10, 2025

(30) Foreign Application Priority Data
Oct. 12, 2022 (DE) 10 2022 126 587.0
Oct. 2, 2023 (DE) 10 2023 126 831.7

(51) Int. Cl. B01D 29/90; B01D 29/25

(52) U.S. Cl. CPC B01D 29/90; B01D 29/25; B01D 2201/02; B01D 2201/202

(57) ABSTRACT

A screen (S1-S14), in particular a pressure screen or a pressure screen device which has an inlet (Z) and at least one axially spaced accept (Ak) and reject (R), is provided. Screen elements (2) are arranged in the inlet space (ZR) of the screen (S1-S14) and in the inlet space (ZR) of the screen elements, spaced radially therefrom, there is a rotor (3) which rotates by means of a driving means (G). In the axial direction between the inlet (Z) and accept (Ak), the rotor comprises at least two rotor regions (A, B) which rotate at different rotational speeds. Each rotor region (A, B) is assigned a corresponding screen basket region (2A, 2B, 2′A, 2′B). These rotor regions can rotate in the same direction or in opposite directions. The screen is operable according to the inflow principle or the outflow principle, optionally also in combination.

The invention relates to a screen, in particular to a pressure screen, or generally speaking, to pressure screen devices. This type of screen has an inlet, and at least one accept outlet and reject outlet each axially spaced therefrom. Furthermore, screen elements are arranged in the usual manner, for example in the form of a screen basket, and in the inlet chamber of the screen elements, spaced radially therefrom, there is a rotor which rotates by means of a driving means.

EP 0 404 624 B1 discloses a method for controlling pressure screen devices and pressure screens. In addition to an inlet, this pressure screen device comprises an accept outlet and a reject outlet which are axially spaced therefrom. Furthermore, a screen element in the form of a screen basket or, generally speaking, of a screen plate is arranged in the pressure screen device. Furthermore, arranged at a radial distance from the screen basket, a screen plate treatment device is provided which is a rotor blade arrangement, with a baffle plate arrangement being provided radially spaced therefrom. The baffle plate arrangement and the screen plate treatment device (rotor) both feed the fiber suspension to the screen plate and are provided with separate drive units, each of which is connected to these devices. This in particular allows the screen plate treatment device (rotor) and the baffle plate arrangement to be driven at the respective desired speed. In this prior art, the rotor elements serve to feed the flow, or to divert it from an axial to a radial flow, to the screen element or screen basket. The rotor element is effective over the entire axial length of the screen element. Arranged downstream is a second rotor blade arrangement with a separate drive unit and a separate speed for the cleaning effect of the screen element (screen basket) by pressure/suction application on the screen element surface. This second rotor blade arrangement sweeps over the entire axial length of the screen element. Both rotor elements are arranged between the inlet and the accept outlet, but the individual rotor elements are connected radially one behind the other and sweep over the entire height of the screen element (screen basket). A different mode of action is therefore realized.

Furthermore, U.S. Pat. No. 3,939,065 of Feb. 17, 1976 and U.S. Pat. No. 3,933,649 of Jan. 20, 1976 disclose screen devices, in particular pressure screen devices, which comprise two first and second screen drums that are conically shaped and radially spaced. Thus, this prior art document shows a two-stage screening or sorting device having two conical screen elements to which two independent drives are assigned.

DE 102 06 595 A1 relates to a non-generic spreading device for wood chips. DE 33 47 115 C2 discloses a conical screen device of a helical conveyor centrifuge. DE 16 37 850 U discloses a screen drum for waste processing.

It is the object of the invention to improve screening efficiency and to reduce energy and operating costs.

According to the invention, a screen, in particular a pressure screen, with an inlet and at least one accept outlet and reject outlet axially spaced therefrom, with screen elements and a rotor arranged radially spaced therefrom, which rotates in the inlet chamber of the screening elements with a drive device, is provided for this purpose. Based on the concept according to the invention, the design of the screen is such that the rotor comprises at least two downstream rotor regions in the axial direction between the inlet and the accept outlet, which rotate at different rotational speeds, and the rotor regions are each assigned to a corresponding screen element region.

This means that the respective rotor regions can be adapted to the consistency and/or the type of material to be screened in order to achieve a considerably improved overall screening efficiency for the screen. Furthermore, the at least two rotor regions, which rotate at different speeds, make it possible to reduce the energy and operating costs of such a screen thanks to the adaptation to the mass or the material to be screened.

Additional preferred embodiments of the invention are described in claims 2 to 25.

On the one hand, the rotor regions can rotate in the same direction but at different speeds or, on the other hand, the rotor regions can rotate in opposite directions. This results in further optimization and adjustment to the properties of the material to be screened.

In a preferred embodiment of the invention, the inlet-side rotor region rotates more slowly than the reject outlet-side or downstream rotor region. This makes it possible for the fed-in material to be screened to initially remain longer on the inlet side than in the subsequent reject outlet-side or the downstream rotor region. This allows the screening process to be optimized and controlled accordingly. With this design, the inlet-side rotor region rotates more slowly by between 10% and 60%, preferably in a range of between around 20% and 40%, than the reject outlet-side, or downstream, rotor region.

Preferably, the screen elements are essentially cylindrical, but they can also be essentially conical. This depends in particular on the design of the screen.

Preferably, the screen elements have different diameters and the rotor regions also have different diameters and suitably work together with the screen elements of different diameters.

Preferably, the rotor blades of the rotor regions are spaced at a different distance from the wall of the screen elements, which means that different screening conditions can be set accordingly. The distance between the rotor blade and the screen element is between 1.5 mm and 10 mm, preferably between 2.5 mm and 6.0 mm.

As can be seen from the Figures of the drawing, the rotor blades of the rotor sections in the inlet chamber can be installed upstream of the screen elements.

A preferred embodiment of the invention is characterized by the fact that the accept flow direction through the screen element is radially inwards (inflow design). If necessary, the flow flows through the at least two screen elements in different radial directions.

In particular, the at least two rotor regions can also have different rotor designs.

Preferably, the rotor regions comprise an open rotor design, particularly for low-consistency applications, and a closed drum design, particularly for high-consistency applications.

In a preferred design of the screen, at least two rotor regions are assigned a common inlet and at least two axially spaced, separate accept outlets are provided.

In a preferred embodiment of the invention, the drive unit for the rotor regions comprises a gear unit with at least two shaft outputs for driving the rotor regions differently. This results in a compact version of a screen that is designed to save space.

Alternatively, the drive unit comprises at least two separate drives. The drive unit comprises an axial hollow shaft for passing through the drive shaft for the other rotor region.

In general, the one or plural drive(s) can be provided at the top of the screen and/or at the bottom of the screen.

In a preferred embodiment, the screen is designed in such a way that, for a design with more than two spaced rotor regions, these will rotate at different speeds and/or have different directions of rotation. This allows the operating conditions to be flexibly adapted to the properties of the material to be screened.

In summary, the invention is based on the main idea that the rotor comprises at least two rotor regions in the axial direction between the inlet and the accept outlet, which regions rotate at different speeds in order to realize an optimized adaptation to the material to be screened and treated. These rotor regions are assigned to corresponding screen element regions.

Additional details, features and advantages of the invention will become apparent from the following description of non-limiting preferred embodiments, in which reference is made to the accompanying drawing.

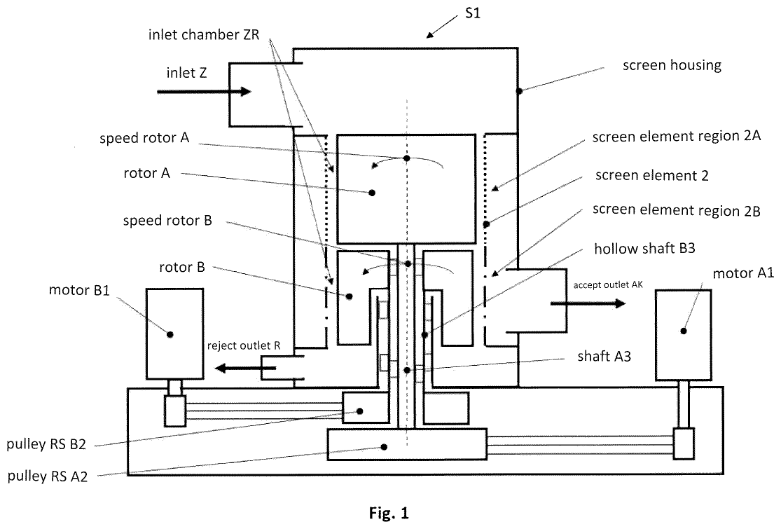

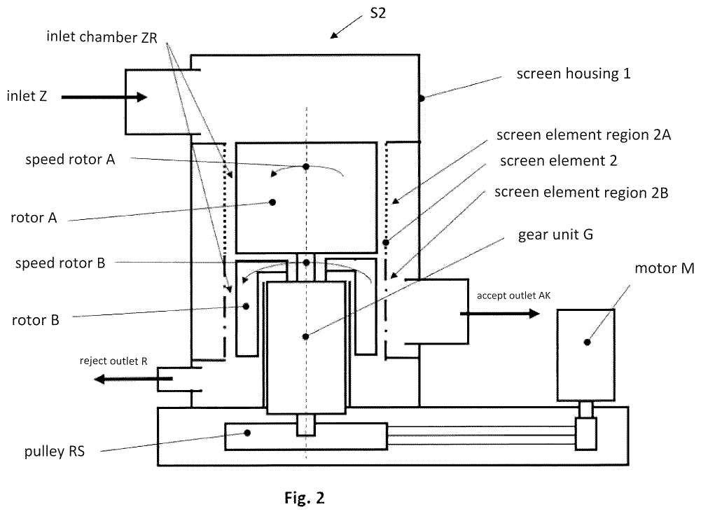

FIGS. 1 to 14 of the drawing are a schematic sectional view each of different embodiments of the essential idea of the invention.

In the Figures of the drawing, identical or similar parts are marked with the same reference sign.

FIG. 1 is a first design of a screen S1 which has a screen housing 1. An inlet Z for the goods to be screened is located near the top of the screen housing 1. At an axial distance therefrom, an accept outlet Ak and a reject outlet R are provided in the screen housing 1 near the bottom. A screen element 2 in the form of a screen basket, which is preferably cylindrical, is arranged inside the inlet chamber in the screen housing 1. A rotor generally designated 3 is arranged at a radial distance from this. The rotor 3 comprises a first rotor region, which is formed by a schematically indicated rotor A, and a second rotor region, which is formed by a schematically indicated rotor B. The drive unit for rotor A comprises a motor A1, a pulley A2 and a drive shaft A3. The second rotor region on the reject outlet side, or downstream of rotor B, has a drive unit comprising a separate motor B1, a pulley B2 and a drive shaft B3 in the form of a hollow shaft. The embodiment of FIG. 1 thus has a screen S1 with two separate drive units for the rotor regions A and the second rotor region B. The drive shaft B3 is designed as a hollow shaft and is mounted in a suitable axial alignment to the drive shaft A3.

Arrows are used to indicate the directions of rotation of rotors A, B. The length of the arrows makes it clear that the inlet-side rotor region A rotates more slowly than the reject-outlet side or downstream rotor region B. Both rotor regions or rotors A, B rotate in the same direction. In the embodiment of screen S1 as seen in FIG. 1, separate drive units are therefore provided for the rotor region A and the rotor region B. Separate screen element regions 2A and 2B (screen basket regions) are assigned to rotor regions A and B respectively.

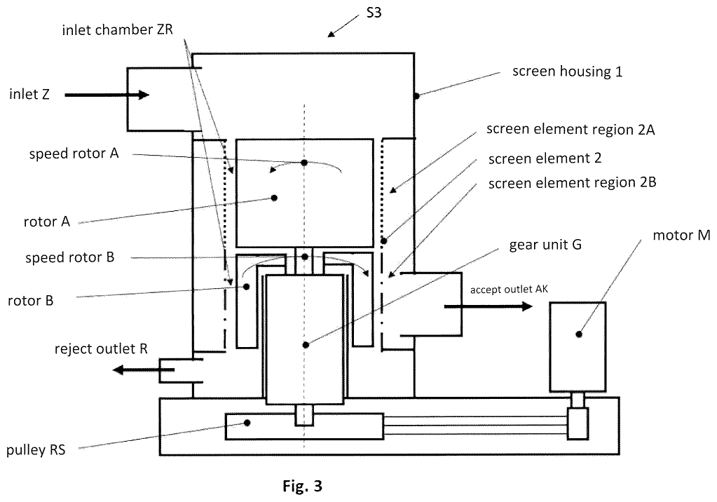

However, in the embodiment shown schematically in FIG. 2, and also in the other FIGS. 2 to 11, a common drive motor M is provided, to which a common pulley arrangement RS is assigned. A gear unit G is provided between the common pulley arrangement RS, which comprises at least two shaft outputs (illustrated schematically) for driving the rotor regions A, B. As shown in the embodiment of FIG. 2, the two rotor regions A and B rotate in the same direction but at different speeds in the region of the screen element 2 (screen basket), as illustrated by the length of the arrows indicating the rotational movement.

In the embodiment of the screen S3 of FIG. 3, however, the rotor regions A and B rotate in opposite directions, with the rotor region A rotating more slowly than the rotor region B, as indicated by the arrows. All other details of this embodiment S3 essentially correspond to the embodiment of the screen S2 of FIG. 2.

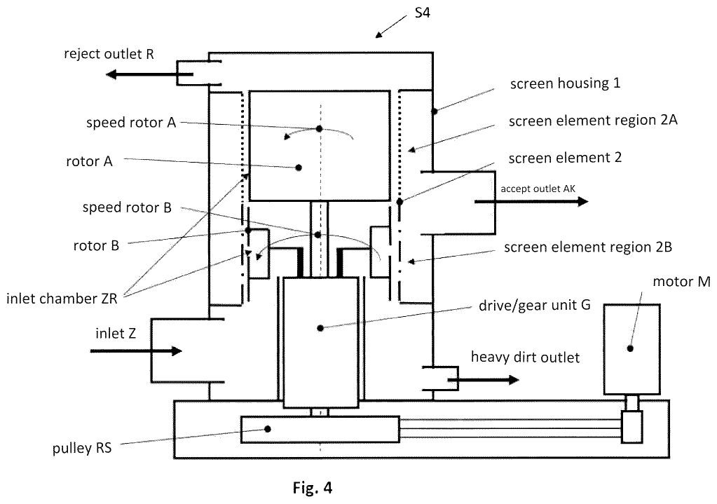

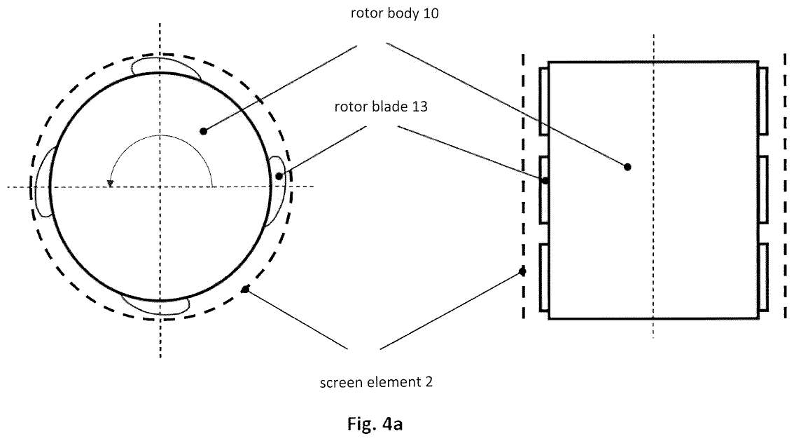

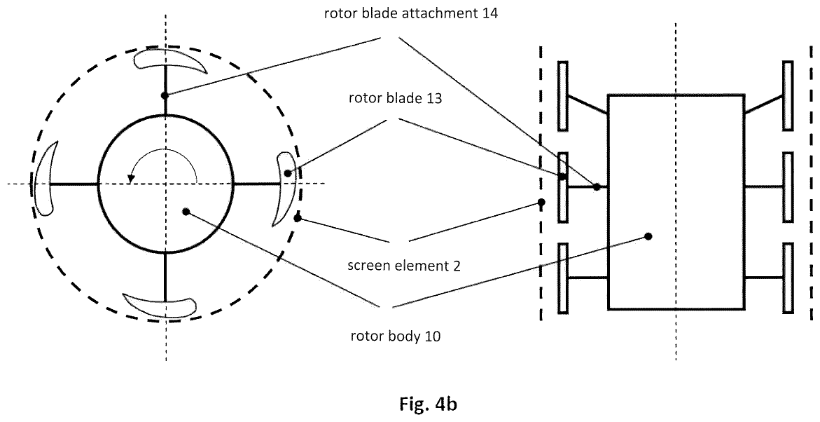

Another alternative design of a screen, which is generally designated S4, is shown in FIG. 4. In contrast to the previous Figures, the inlet Z is arranged near the bottom of the screen S4, while the reject outlet is arranged near the top of the screen S4, and the accept outlet Ak is arranged approximately axially centered between the reject outlet R and the inlet Z. Moreover, this screen S4 has a heavy dirt separation outlet 5. Furthermore, the embodiment S4 illustrated in FIG. 4 comprises a combination of different rotor design variants, namely a drum design for high-consistency applications and an open rotor design for low-consistency applications. Further details of the drum design for high-consistency applications are illustrated schematically in FIG. 4a. The drum design has a cylindrical rotor body 10, with the rotor blades 11 being attached to the outer wall of the drum-shaped rotor body. In FIG. 4, for example, the rotor region A has a drum design.

FIG. 4b shows an open rotor design which is intended for low-consistency applications and which constitutes rotor region B or rotor B. The open rotor design shown in FIG. 4b comprises a centrally arranged rotor body 12, to which the rotor blades 13 are attached by means of a rotor blade attachment 14 . These rotor blades 13 also sweep over the inner surface of the screen element 2, as in FIG. 4a.

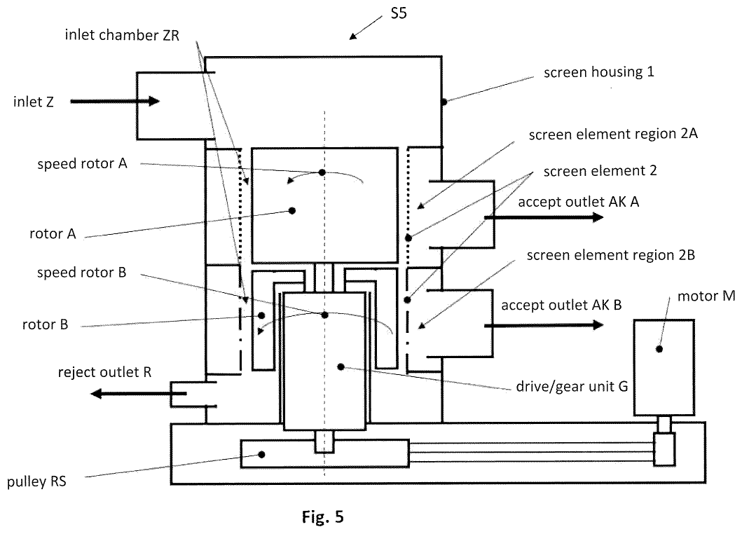

FIG. 5 shows an embodiment of a screen S5 in which the rotor regions or rotors A, B have different speeds, as realized in the preceding embodiments either by using separate drive units or a gear unit G. In the embodiment of the screen S5, the screen element 2 comprises two screen elements 2a and 2b. Separate accept outlets Ak1 and Ak2 are assigned to each of these screen elements 2a, 2b.

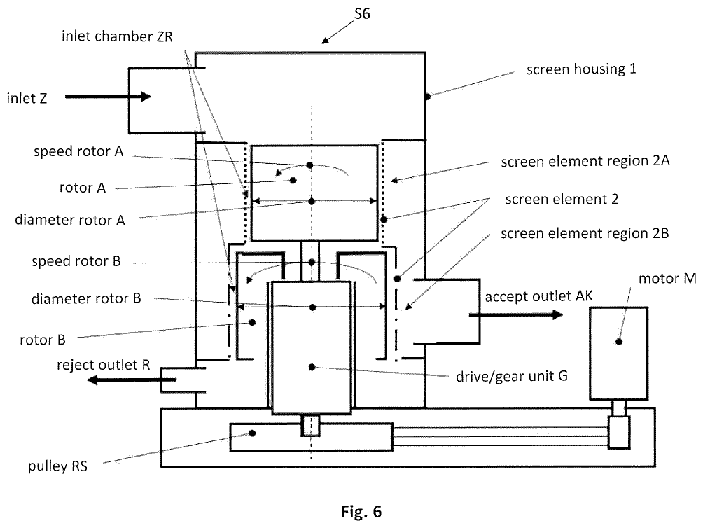

FIG. 6 shows a screen designated in its entirety as S6. The basic design and structure are essentially the same as those of the screen S2 shown in FIG. 2. However, the screen elements 2a′ and 2b here are of different diameter and/or the rotor regions A, B may also differ in diameter. The assigned screen element regions are designated 2′A and 2′B. By changing the diameters of the screen elements 2a′, 2b′ and/or by changing the diameters of the rotor regions A, B, different screening conditions can be set accordingly.

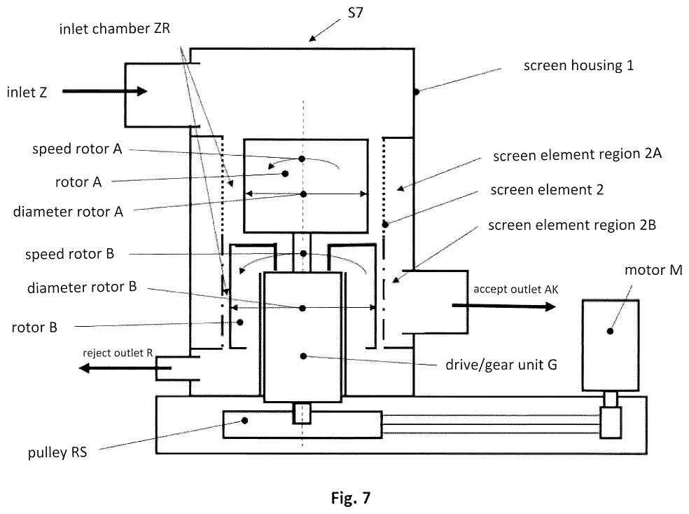

FIG. 7 shows an embodiment in which the screen S7 has rotor regions A, B of a different diameter, while the diameter of the screening elements 2 in the form of a screen basket remains the same. This makes it possible to realize different distances between the screen element 2 and the outer surface of the rotor regions A, B. In the embodiment of FIG. 7, the smaller-diameter rotor region A is arranged close to the inlet side, while the larger-diameter rotor region B is arranged on the accept outlet side. Here too, the screening conditions between rotor region A and rotor region B can be adapted to the material to be screened. Of course, the smaller-diameter region and the larger-diameter rotor region can also be selected in the reverse order to the one shown in FIG. 7. The distance between the rotor blade 13 and the screen element 7 is between 5 mm and 10 mm, preferably between 2.5 mm and 6.0 mm. A special design is characterized by the fact that the rotor blades of the inlet-side rotor region (A) are by between 0% and 30% closer to the wall of the screen elements (2, 2′, 2a) than the rotor blades of the reject outlet-side or downstream rotor region.

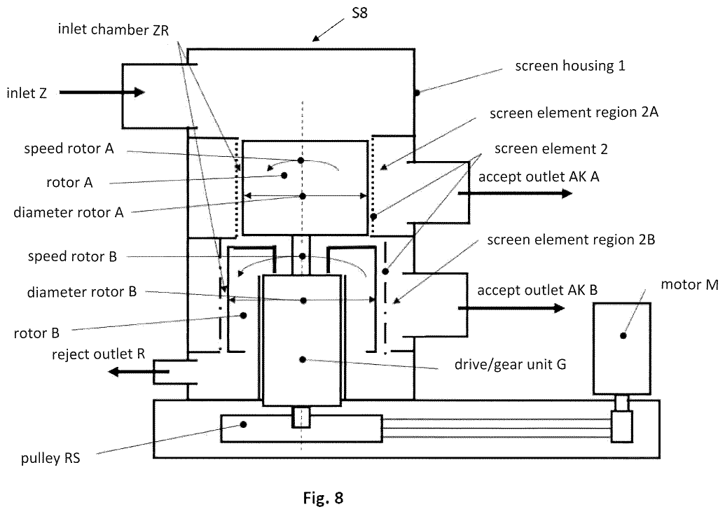

FIG. 8 shows a screen S8 that is based on the basic design of the screen S5 shown in FIG. 5, but whose screen elements 2a, 2b have different diameters than those of the embodiment of FIG. 6.

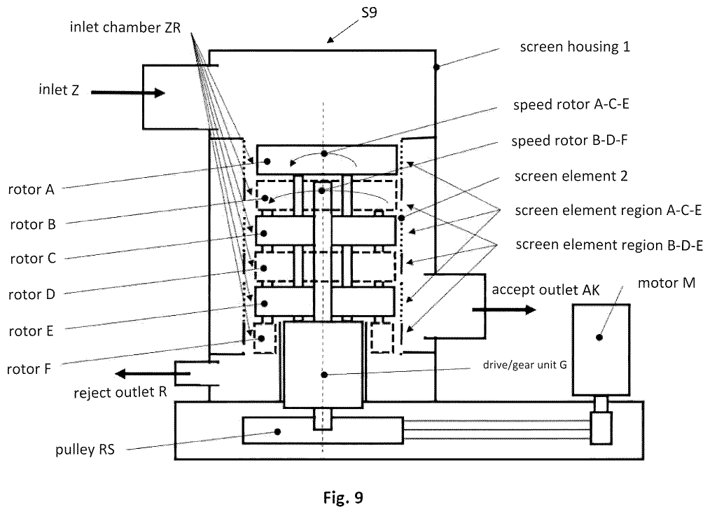

FIG. 9 shows a screen designated in its entirety with S9, in which plural rotor regions A to F are provided, schematically illustrated with rotors A to F. These rotor regions A to F rotate at different speeds or in different directions. Otherwise, the basic design of the screen S9 is the same as that of the screens shown and explained above. Separate screen element regions 2A, 2B (screen element regions A-C-E; B-D-F) are assigned to each rotor region.

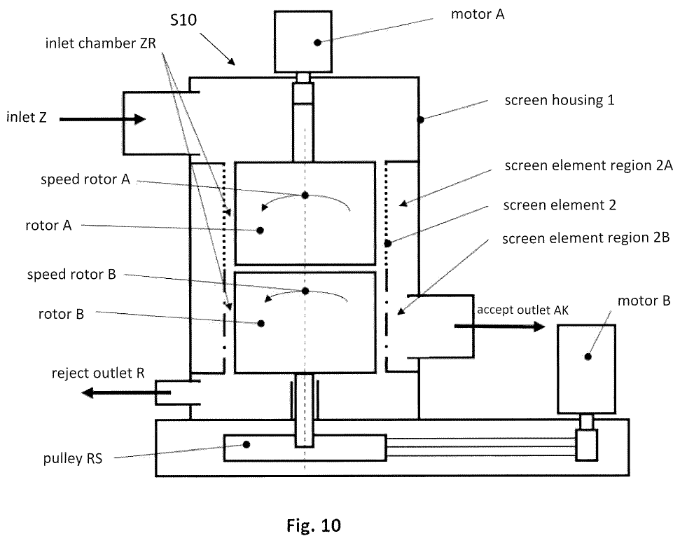

The screen shown in its entirety in FIG. 10 essentially has the same basic structure as the one of FIG. 1, however, the drive motor A1 is located near the top of the screen S10. This makes it possible to avoid the one-sided complex shaft/hollow shaft drive through the pressure screen housing base shown in FIG. 1.

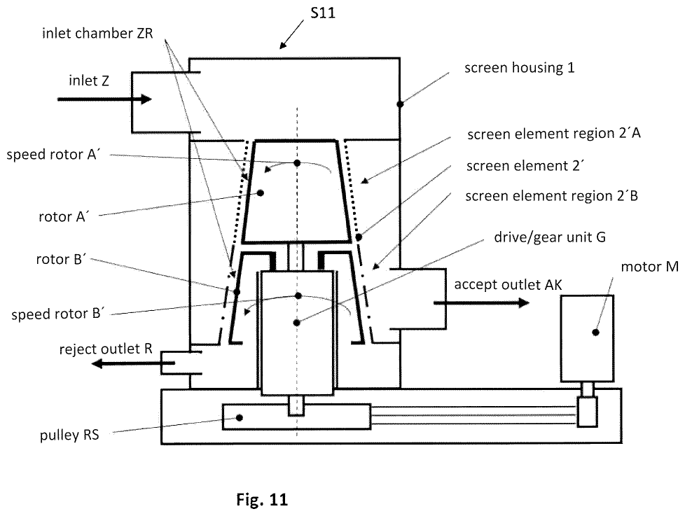

FIG. 11 schematically shows a screen S11 in which conically shaped rotor regions A′, B′ are provided. Similarly, the screen element 2′is also correspondingly conical and has assigned screen element regions 2′A, 2′B. The drives for the rotor regions are designed in accordance with the embodiments explained above.

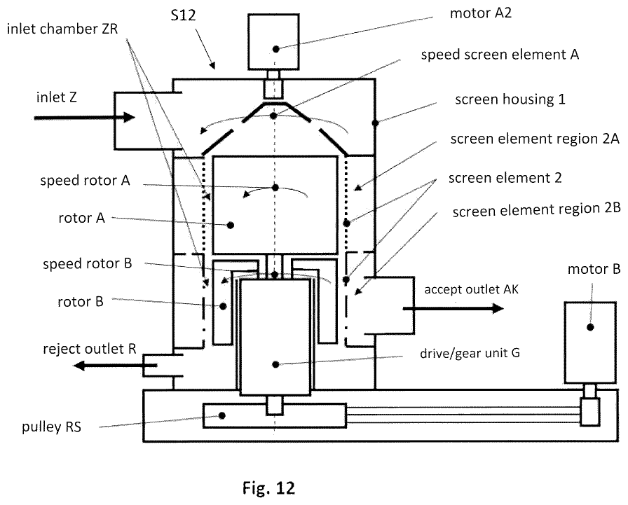

Finally, FIG. 12 shows a screen S12, which in terms of its basic design is similar to the screen S10 of FIG. 10, but it is additionally illustrated in more detail here that the screen element in the form of the screen basket 2 is also rotationally driven by means of the motor A2, which is arranged above the screen housing 1.

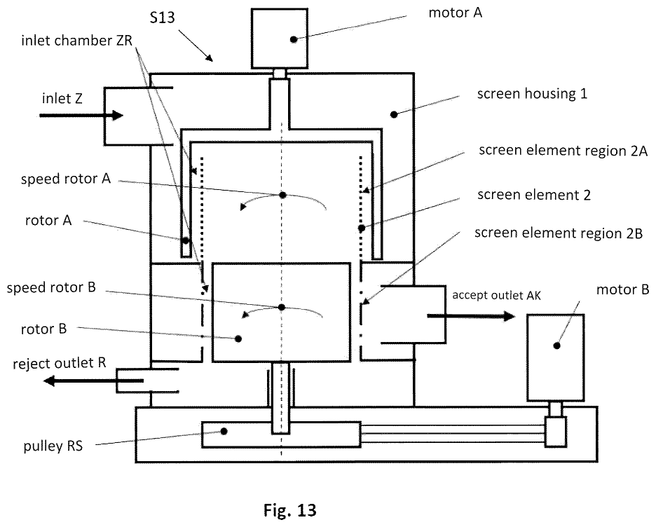

FIG. 13 shows a screen S13, which is similar to the screen S10 in terms of the basic design of the arrangement of the drives. However, the rotor A is arranged on the outer area of the screen element region A2. The suspension to be screened thus flows from the outer diameter of the screen element 2 into the interior of the screen element 2. The flow direction of this arrangement is centripetal; this screening region therefore operates according to the inflow principle. The accept flow of the screen element 2A is now the inlet flow of the screen element 2B which is subsequently treated in the rotor region B in a radial outward direction (outflow principle) by the screen element 2B. This means that the screening material to be treated is treated in interdependent stages.

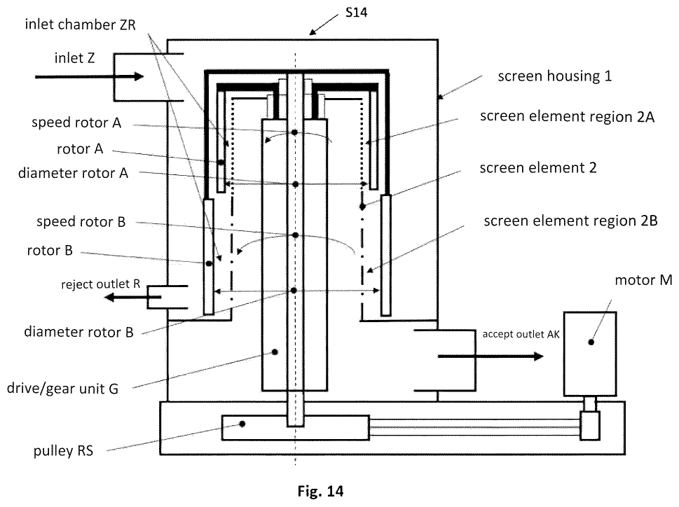

FIG. 14 shows a screen S14 in which both rotor regions A and B operate according to the inflow principle. The inlet Z here is from the outer diameter of the screen element 2. Each rotor region is driven by a shaft output with a different rotor speed assigned to a rotor region. In FIG. 13, rotor B is arranged at a greater distance from screen element 2 than rotor A.

The screen element can be designed in various ways. Screen elements 2 with slotted openings made of profile bar and ring arrangements, as well as perforated sheet metal constructions with slot-shaped, round hole-shaped or other opening geometries can be realized. Fabrics can also be used as screen elements.

It goes without saying that the invention shall not be limited to the preferred embodiment explained and shown above, but that numerous changes and modifications are possible, in particular combinations of the preferred embodiment are also possible. However, all preferred embodiments and all embodiment variants have in common that they have at least two different rotor regions A, B, which preferably rotate at different speeds, and that the different rotor regions A, B are each assigned separate screen element regions 2A, 2B, 2′A, 2′B.

### Reference Signs

S1 to S14 screen as a whole
1 screen housing
2 screen element in the form of a screen basket
2A, 2B screen element region
2′screen element of conical design in FIG. 11
2′A, 2′B screen element region
3 rotor
5 heavy dirt outlet
10 rotor body as a drum design (FIG. 4a)
12 open rotor design (FIG. 4b)
13 rotor blade/rotor blade attachment
14 rotor blade attachment
M common drive motor in FIGS. 2 to 11
G gear unit
A first rotor region or rotor (inlet side)
B second rotor region or rotor (accept outlet side)
Ak accept outlet
R reject outlet
Z inlet
ZR inlet chamber
RS pulley arrangement (overall)
drive unit for rotor A, comprising:
   motor A1,
   pulley A2
   drive shaft A3
drive unit for rotor B, comprising:
   motor B1
   pulley B2
   drive shaft B3 designed as a hollow shaft

1-26. (canceled)

27. A screen, in particular pressure screen, comprising
an inlet (Z),
at least one axially spaced accept outlet (Ak) and reject outlet (R),
screen elements (2, 2′), and
a rotor (3) which is arranged radially spaced therefrom and rotates in the inlet chamber (ZR) of the screen elements (2, 2′) by means of a driving means,
wherein the rotor (3) comprises at least two downstream rotor regions (A, B) in the axial direction between the inlet (Z) and the accept outlet (Ak), and the rotor regions rotate at different speeds and each are assigned to corresponding screen element regions (2A, 2B; 2′A, 2′B).

28. The screen according to claim 27, wherein the rotor regions (A, B) rotate in the same direction.

29. The screen according to claim 27, wherein the rotor regions (A, B) rotate in opposite directions.

30. The screen according to claim 27, wherein the rotor region (A) on the inlet side rotates more slowly than the reject outlet-side or downstream rotor region (B).

31. The screen according to claim 30, wherein the rotor region (A) on the inlet side rotates more slowly by between 10% and 60%, preferably in a range of about between 20% and 40%, than the reject outlet-side or downstream rotor region (B).

32. The screen according to claim 27, wherein the rotor regions (A, B) are essentially of a cylindrical design.

33. The screen according to claim 27, wherein the screen elements (2, 2′) are essentially of a cylindrical design.

34. The screen according to claim 27, wherein the rotor regions (A, B) are essentially of a conical design.

35. The screen according to claim 34, wherein the screen elements (2′) are essentially of a conical design.

36. The screen according to claim 27, wherein each of the screen elements (2a) have different diameters.

37. The screen according to claim 27, wherein the rotor regions (A, B) have different diameters and suitably cooperate with the screen elements (2a) of different diameters.

38. The screen according to claim 27, wherein the rotor blades of the rotor regions (A, B) are arranged at a different distance from the wall of the screen elements (2, 2′, 2a).

39. The screen according to claim 27, wherein the distance between the rotor blade ( 3) and the screen element (2) is between 1.5 mm and 10 mm.

40. The screen according to claim 27, wherein the rotor blades of the inlet-side rotor region (A) are by between 0% and 30% closer to the wall of the screen elements (2, 2′, 2a) than the rotor blades of the reject outlet-side or downstream rotor region (B).

41. The screen according to claim 38, wherein the rotor blades (13) of the rotor regions (A, B) in the inlet chamber (ZR) are positioned upstream of the screen elements (A, B).

42. The screen according to claim 27, wherein the accept flow direction through the screen element (A, B) is directed radially outwards.

43. The screen according to claim 27, wherein the accept flow direction through the screen element (A, B) is directed radially inwards.

44. The screen according to claim 27, wherein the flow passes through the at least two screen elements (A, B) in different radial directions.

45. The screen according to claim 27, wherein the at least two rotor regions (A, B) take the form of different rotor designs.

46. The screen according to claim 27, wherein the rotor regions (B) comprise an open rotor design (12) for low-consistency applications and a closed drum design (10) for high-consistency applications.

47. The screen according to claim 27, wherein the at least two rotor regions (A, B) are assigned a common inlet (Z) and at least two axially spaced, separate accept outlets (Ak1, Ak2).

48. The screen according to claim 27, wherein the drive unit comprises a gear unit (G) with at least two shaft outputs for driving the rotor regions (A, B).

49. The screen according to claim 27, wherein the drive unit comprises at least two separate drives.

50. The screen according to claim 48, wherein the drive unit comprises an axial hollow shaft (B3), and the drive shaft passes through the axial hollow shaft (B3) for the respective other rotor region (B, A).

51. The screen according to claim 27, wherein a drive (A1) is provided on the top of the screen (S10), on the bottom of the screen (S10), or both.

52. The screen according to claim 27, wherein the screen comprises more than two spaced rotor regions (A to F) and the spaced rotor regions rotate at different speeds, have different directions of rotation, or both.
